(19) United States
(12) Patent Application Publication
(10) Pub. No.: US 2026/0159087 A1
(43) Pub. Date: Jun. 11, 2026

(54) SYSTEM AND METHOD FOR ELECTRONIC CREEP ON ELECTRIFIED VEHICLES

(71) Applicant: FCA US LLC, Auburn Hills, MI (US)

(72) Inventors: Krishna Nitin Mukkawar, Chennai (IN); Godla Sagar Naidu, Auburn Hills, MI (US); Francis Carr, Auburn Hills, MI (US)

(21) Appl. No.: 18/976,680

(22) Filed: Dec. 11, 2024

(51) Int. Cl. B60W 30/18; B60W 10/08; B60W 10/184

(52) U.S. Cl. CPC B60W 30/18063; B60W 10/08; B60W 10/184; B60W 2520/00; B60W 2520/28; B60W 2540/10; B60W 2540/14

(57) ABSTRACT

A vehicle system for an electrified vehicle that implements electronic creep torque control includes an electric motor, a friction brake and a controller. The electric motor provides drive torque to a driveline that drives vehicle wheels. The friction brake applies a friction brake input to a vehicle wheel based on an input from a brake pedal. The controller: determines whether a creep mode is activated, the creep mode including an electric motor input to the driveline; determines, based on the creep mode being activated, whether a brake pedal input is received by the brake pedal; commands, based on the brake pedal input being received, the friction brake to apply a friction brake input; determines whether a speed of the electrified vehicle is zero; and commands, based on a determination that the electrified vehicle speed is zero, the electric motor to ramp out of the electric motor input.

### FIELD

The present disclosure relates generally to a system and method for implementing electronic creep torque control for electrified vehicles.

### BACKGROUND

Vehicle creep torque refers to the minimal amount of torque required to overcome friction and move a vehicle at a slow, steady pace without driver input to the accelerator pedal. In the case of electrified vehicles, such as but not limited to, battery electric vehicles (BEV), range extender electric vehicles (REEV), fuel cell electric vehicles (FCEV) and hybrid electric vehicles (HEV), creep torque has been produced by motors connected with axles in the drivetrain that propel the vehicle. This functionality can be enabled and disabled in the above applications by an electronic creep (e-creep) feature. Typically, the creep torque is managed by a controller according to different vehicle operating conditions based on various inputs. In use, when a driver presses the brake pedal while creeping, the controller adds friction torque as per the driver input on the brake pedal. Concurrently, the controller also reduces motor torque. In some instances when adjusting both brake friction torque and e-motor torque a double reduction of acceleration can lead to drivability issues and driver dissatisfaction. As such, there remains a need for improvement in the relevant art.

### SUMMARY

In one example aspect of the invention, a vehicle system for an electrified vehicle that implements electronic creep torque control includes an electric motor, a friction brake and a controller. The electric motor provides drive torque to a driveline that drives vehicle wheels for propelling the vehicle. The friction brake applies a friction brake input to at least one of the vehicle wheels based on an input from a brake pedal. The controller: determines whether a brake pedal input is received by the brake pedal; commands, based on the brake pedal input being received, the friction brake to apply a friction brake input; determines whether a creep mode is activated, the creep mode including an electric motor input to the driveline; determines whether a speed of the electrified vehicle is zero; and commands, based on a determination that the electrified vehicle speed is zero, the electric motor to one of ramp in and ramp out of the electric motor input.

In another aspect, the controller determines whether the creep mode is activated based on a drive mode input.

In some implementations, the controller determines whether the creep mode is activated based on an accelerator pedal input.

In some configurations, the controller determines whether the creep mode is activated based on a brake pedal input.

According to additional examples, the controller determines whether the creep mode is activated based on a vehicle speed.

In additional implementations, the controller determines whether the creep mode is activated based on a shifter position.

In examples, the controller determines whether the creep mode is activated based on a park brake input.

In other examples, the controller determines whether a speed of the electrified vehicle is zero based on an input from a wheel speed sensor.

In additional examples, control determines whether a friction brake input is less than a threshold value; and based on a determination that the friction brake input is less than the threshold value, commands the electric motor to ramp in the electric motor input.

A method for implementing electronic creep torque control for an electrified vehicle that includes an electric motor that provides drive torque to a driveline that drives vehicle wheels for propelling the vehicle; and a friction brake that applies a friction brake input to at least one of the vehicle wheels based on an input from a brake pedal, the method comprises: determining, at a controller, whether a brake pedal input is received by the brake pedal; commanding at the controller and based on the brake pedal input being received, the friction brake to apply a friction brake input; determining whether a creep mode is activated, the creep mode including an electric motor input to the driveline; determining at the controller whether a speed of the electrified vehicle is zero; commanding at the controller and based on a determination that the electrified vehicle speed is zero, the electric motor to one of ramp in and out of the electric motor input.

In another aspect of the method, the controller determines whether the creep mode is activated based on a drive mode input.

In some implementations of the method, the controller determines whether the creep mode is activated based on an accelerator pedal input.

In some configurations of the method, the controller determines whether the creep mode is activated based on a brake pedal input.

According to additional examples of the method, the controller determines whether the creep mode is activated based on a vehicle speed.

In additional implementations of the method, the controller determines whether the creep mode is activated based on a shifter position.

In examples of the method, the controller determines whether the creep mode is activated based on a park brake input.

In other examples of the method, wherein the controller determines whether a speed of the electrified vehicle is zero based on an input from a wheel speed sensor.

In additional examples, the method further includes determining whether a friction brake input is less than a threshold value; and based on a determination that the friction brake input is less than the threshold value, commanding the electric motor to ramp in the electric motor input.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic block diagram of an exemplary vehicle system according to the principles of the present disclosure;

FIG. 2 is an example electronic creep torque control implemented by an exemplary controller of the vehicle system of FIG. 1 according to the principles of the present disclosure;

FIG. 3 is a plot of exemplary vehicle speed, brake pedal input, friction torque input, creep torque input, ideal total torque and total torque over time at the vehicle wheel according to one Prior Art example;

FIG. 4 is an exemplary block diagram illustrating a brake torque and creep torque management strategy implemented by a controller according to the Prior Art example shown in FIG. 3;

FIG. 5 is a plot of exemplary vehicle speed, minimum e-motor torque and brake pedal input over time at the vehicle wheel according to one example of the present disclosure;

FIG. 6 is a plot of exemplary vehicle speed, brake pedal input, friction torque input, creep torque input, ideal total torque and total torque over time at the vehicle wheel according to one example of the present disclosure;

FIG. 7 is a plot of exemplary vehicle speed, minimum e-motor torque and brake pedal torque over time at the vehicle wheel during a braking event from high speed according to one example of the present disclosure;

FIG. 8 is an exemplary method of implementing electronic creep torque control according to one example of the present disclosure; and

FIG. 9 is an exemplary method of implementing electronic creep torque control according to another example of the present disclosure.

### DESCRIPTION

As identified above, on electrified vehicles, creep torque has been produced by electric motors connected with axles in the drivetrain that propel the vehicle. Typically, the creep torque is managed by a controller according to different vehicle operating conditions based on various inputs. In use, when a driver presses the brake pedal while creeping, the controller adds friction torque as per the driver input on the brake pedal. Concurrently, the controller also reduces motor torque. In some instances when adjusting both brake friction torque and e-motor torque a double reduction of acceleration can lead to drivability issues and driver dissatisfaction.

The present disclosure provides a system and method for implementing electronic creep torque control. Creep torque is modified not just based on brake pedal input but also by considering vehicle speed which helps achieve a more expected deceleration of the vehicle. In particular, the brake friction torque and the e-motor torque are not both adjusted during creep mode upon detection of a brake pedal input. Rather, just brake friction torque is adjusted. Control only modifies the e-torque of the electric motor(s) after determining that the vehicle speed has reached zero. In examples, once control determines that the vehicle speed has reached zero, the e-torque input can be ramped out.

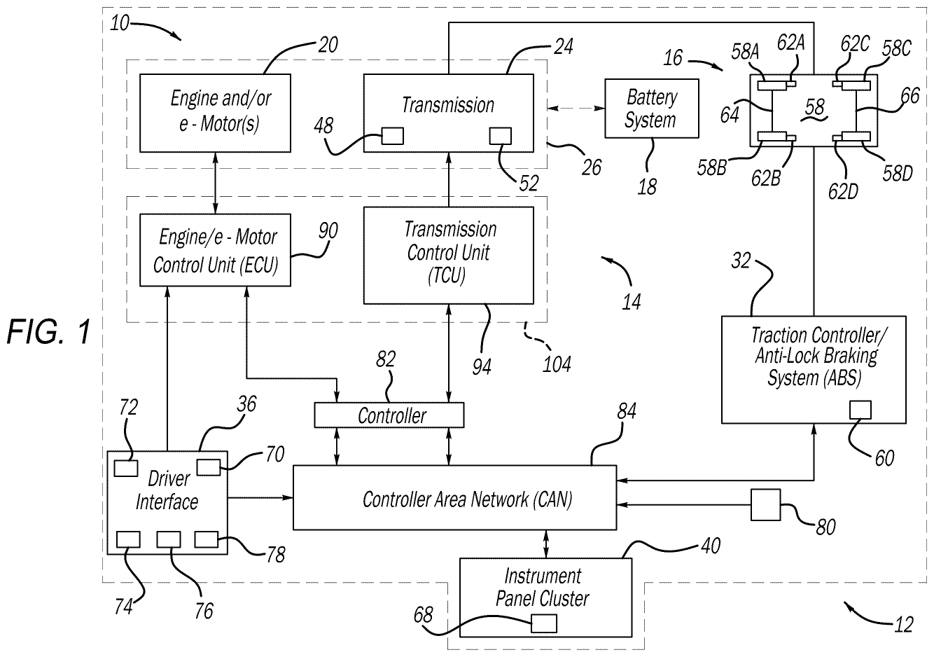

With initial reference to FIG. 1, an exemplary vehicle system is schematically shown and generally identified at reference numeral 10. The exemplary vehicle system 10 is associated with an exemplary electrified vehicle 12 and includes a powertrain 14 configured to transfer drive torque to a driveline 16 of the vehicle 12 for propulsion. The powertrain 14 generally comprises a high voltage battery system 18, a motor 20 including at least one of an internal combustion engine (ICE) and one or more electric motors, and a transmission 24. The motor 20 and the transmission 24 can be collectively referred to herein as a drive module 26. While the exemplary implementation includes a transmission 24, in some examples the powertrain 14 does not include a transmission.

The vehicle system 10 further includes a traction controller and/or an anti-lock brake system (ABS) 32. While shown together it will be appreciated that the vehicle system can have a dedicated traction control system that operates independent of an anti-lock brake system. The vehicle system 10 further includes a driver interface 36 and an instrument panel or cluster 40. The instrument panel or cluster 40 can include any interface device, such as a driver information center, and/or vehicle infotainment system capable of receiving input from a driver.

As identified above, the motor 20 includes one or more electric motors. As such, the electrified vehicle 12 can be any electrified vehicle configuration including a battery electric vehicle (BEV), a range extender electric vehicles (REEV), a fuel cell electric vehicles (FCEV) and a hybrid electric vehicle (HEV). The transmission 24 includes various transmission speed sensors, such as input and output transmission shaft speed sensors 48 and various shift sensors 52, to provide a signal to an associated control system indicative of a transmission gear selected. The transmission 24 and traction controller 32 are coupled or selectively coupled, directly or indirectly, to one or more wheels 58 of vehicle 12, as is known in the art. In the exemplary vehicle system, all of the wheels 58 are drive wheels that receive torque input, however it will be appreciated that only some of the wheels 58 can be configured as drive wheels that deliver torque.

The wheels 58 are identified individually as front wheels 58A, 58B and rear wheels 58C, 58D. The wheels 58A, 58B, 58C and 58D each have wheel speed sensors 62A, 62B, 62C and 62D. In the example shown, the front wheels 58A and 58B are selectively coupled by a front axle 64. Similarly, the rear wheels 58C and 58D are selectively coupled by a rear axle 66. In the exemplary implementation illustrated, the traction controller 32 is controlled to activate foundation brakes 60.

The instrument panel cluster 40 includes various indicators, such as an e-creep input and indicator 68. In examples, the driver can enable and disable the e-creep functionality at the instrument panel cluster 40. The driver interface 36 includes a steering wheel 70 and a brake pedal 72. The driver interface 36 further includes a driver input device, e.g., an accelerator pedal 74, for providing a driver input, e.g., a torque request, for the motor 20. The driver interface 36 can further include a park brake 76. The driver interface 36 or vehicle interior also includes a transmission shift request device, such as a shift lever or rotary shifter 78, for the driver to request a desired gear of the transmission 24. The shift lever or rotary shifter 78 can provide conventional transmission options including park, reverse, neutral, drive and low.

One or more controllers 82 are utilized to control the various vehicle components or system discussed above. In one exemplary implementation, various individual controllers are utilized to control the various components/systems discussed herein and are in communication with each other and/or the various components/systems via a local interface 84. In this exemplary implementation, the local interface 84 is one or more buses or other wired or wireless connections, as is known in the art. In the example illustrated in FIG. 1, the local interface 84 is a controller area network (CAN). The CAN 84 may include additional elements or features, which have been omitted for simplicity, such as controllers, buffers (cache) drivers, repeaters and receivers, among many others, to enable communications. Further, the CAN 84 may include address, control and/or data connections to enable appropriate communications among the components/systems described herein. The vehicle system 10 also includes sensors 80. The sensors 80 can provide inputs to the CAN 84 and therefore the controller 82 indicative of various operating conditions as will be described herein.

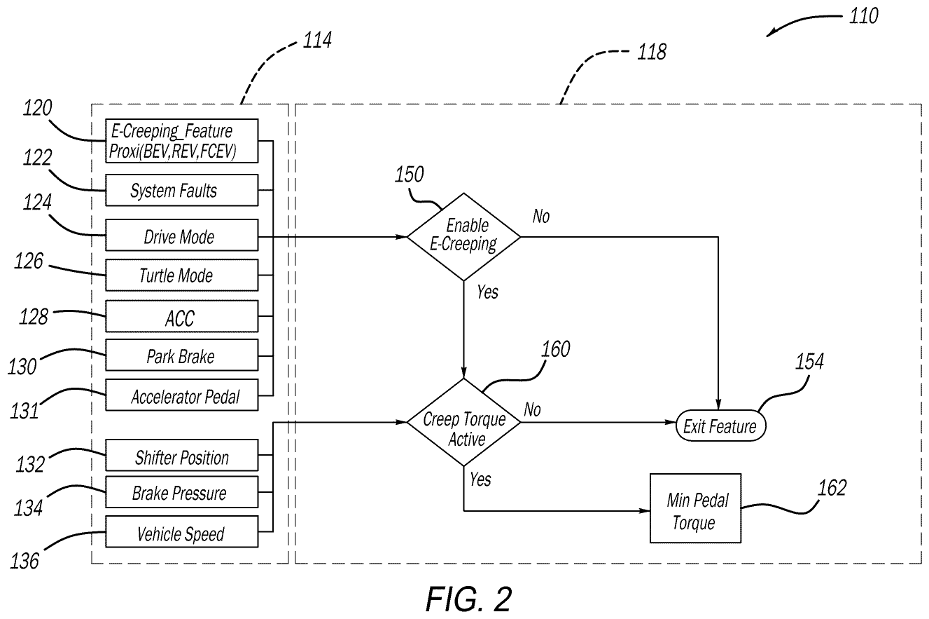

With continued reference to FIG. 1 and additional reference to FIG. 2, additional features of the present disclosure will be described. An example electronic creep torque control 110 implemented by the controller 82 of the vehicle system 10 includes control steps 118 that are implemented based on various inputs 114 received. By way of example, the inputs 114 can include an e-creeping feature input 120, a system faults input 122, a drive mode input 124, a turtle mode input 126, an adaptive cruise control (ACC) input 128, a park brake input 130, an accelerator pedal input 131, a shifter position input 132, a brake pressure input 134 and a vehicle speed input 136. Some or all of the inputs can be provided by the sensors 80 and the components of the driver interface 36. In general, the e-creeping feature input 120 is enabled by the controller 82 to provide creep torque if it is available in specific applications. The system faults input 122 can be indicative of any system faults. The controller 82 can enable creep torque based on no faults being detected. The controller 82 enables creep torque if a selected drive mode (such as at shifter 87 and/or various drive modes selected at the instruments panel cluster 68) allows e-creeping. Control enables creep torque when the park brake 76 is not applied. Control enables creep torque when no input is detected from the accelerator pedal 74. Control enables creep torque when turtle mode is not active. Control enables creep torque when adaptive cruise control (ACC) is not active.

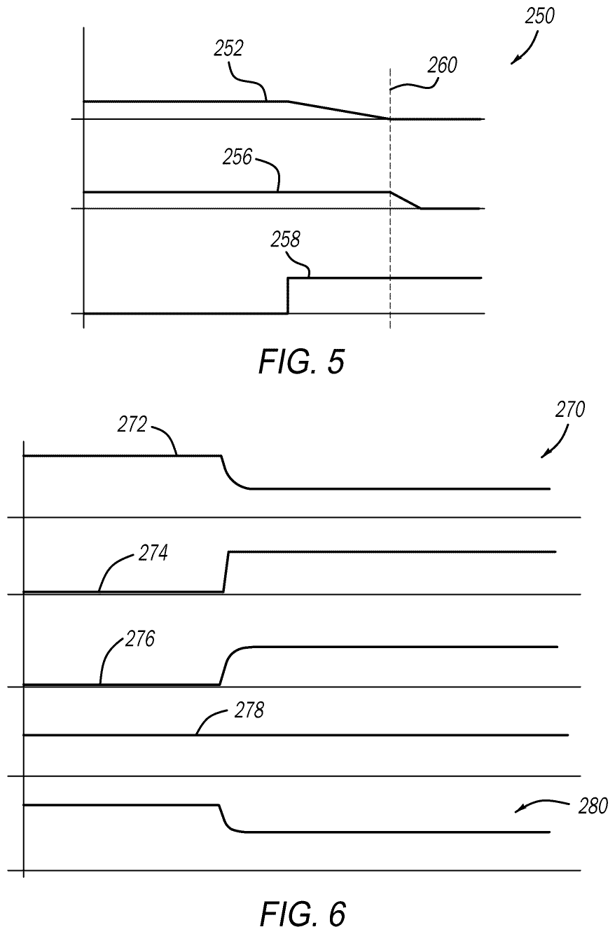

At 150 control determines if e-creeping has been enabled. In examples, e-creeping can be enabled based on one or more of the inputs 120, 122, 124, 126, 128, 130 and 131 satisfying an enable condition. If e-creeping is not enabled, control exits at 154. If e-creeping has been enabled, control determines whether creep torque is active at 160. Control determines whether creep torque is active based on one or more of the inputs 132, 134 and 136 satisfying an activation condition. In Prior Art examples, the magnitude of the creeping torque is related to the brake pressure magnitude (brake boost pressure). The control modulates the creep torque based on the brake boost pressure. The more the brake boost pressure, the more the torque is gradually reduced to zero Nm. According to the present disclosure, control modulates the creep torque based on brake boost pressure and vehicle speed both (see FIGS. 5-7 and related discussion). If creep torque is not active at 160, control exits at 154. If creep torque is activated at 160, control ramps in and out creep torque through minimum pedal torque at 162.

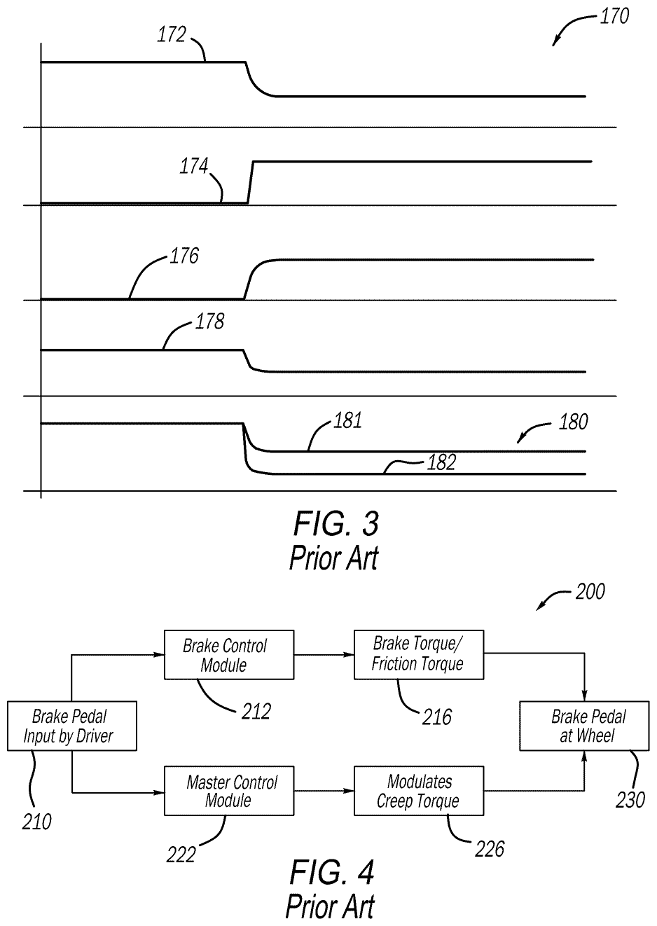

With additional reference now to FIG. 3, additional description will be made of a creep torque control according to one Prior Art example. FIG. 3 is a plot 170 of exemplary vehicle speed 172, brake pedal input 174, friction torque input 176, creep torque input 178, and ideal total torque 181 and total torque at the wheel 182 (collectively identified at 180) over time according to one Prior Art example. As shown at 180, the ideal total torque and the total torque at the wheel are not aligned. This results in creep being more difficult to control with the brake pedal and driver perception of creep mode being unfavorable.

FIG. 4 is an exemplary block diagram 200 illustrating a brake torque and creep torque management strategy implemented by a controller according to the Prior Art example shown in FIG. 3. Control receives a brake pedal input from the driver 210. A brake control module 212 and a master control module 222 receive the brake pedal input. The brake control module 212 communicates a signal to apply brake/friction torque at 216. Concurrently, the master control module 222 communicates a signal to modulate creep torque 226 using the e-motor(s). A total torque 230 at the wheel is therefore based on both the brake/friction torque 216 and the modulated creep torque 226. As discussed above, these competing torque inputs can produce an unfavorable creep mode by the driver with competing torques.

FIG. 5 is a plot 250 of exemplary vehicle speed 252, minimum e-motor torque 256 and brake pedal input 258 over time at the vehicle wheel 58 according to one example of the present disclosure. As shown, when the electrified vehicle 12 is applying minimum torque and creeping, and a brake input is detected from the brake pedal 72, control adds friction torque 258 based on driver input at the brake pedal 72. However, control does not ramp out of e-torque 256 until the electrified vehicle 12 reaches zero speed at 260. Control can determine whether the vehicle has reached zero speed by any suitable means such as by inputs from at least one of the wheel speed sensors 62A-62D. This results in adequate deceleration which is expected by the driver and not more than that.

With additional reference now to FIG. 6, additional description will be made of a creep torque control according to the present disclosure. FIG. 6 is a plot 270 of exemplary vehicle speed 272, brake pedal input 274, friction torque input 276, creep torque input 278, and ideal total torque and total torque 280 over time at the vehicle wheel 58. As shown at 278, the creep torque 278 remains steady and provides a desired behavior expected by the driver. Moreover, the ideal total torque 28 is in line with the total torque at the wheel contributing to a satisfying torque feedback to the driver during creep mode after a brake pedal input 274.

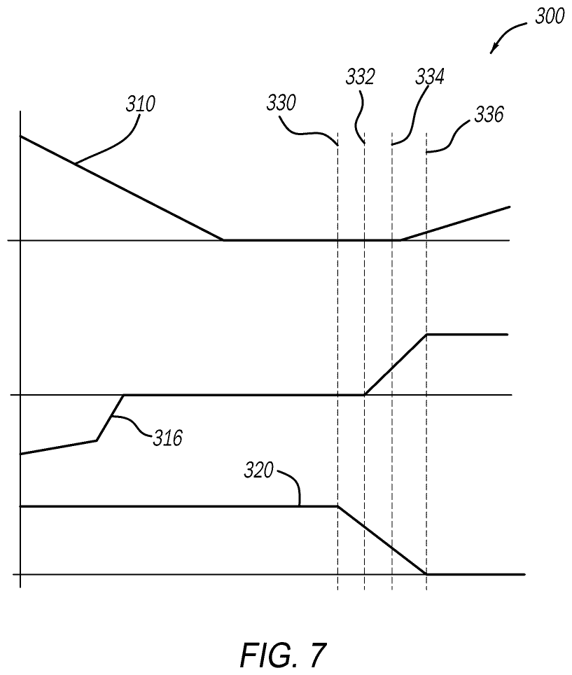

FIG. 7 is a plot 300 of exemplary vehicle speed 310, minimum e-motor e-torque 316 provide from the motor(s) 20 and brake pedal torque 320 over time at the vehicle wheel 58 during a braking event from high speed according to one example of the present disclosure. As shown, minimum torque should not go positive while the driver is consistently braking and the vehicle 12 is moving. Once the vehicle 12 is stationary, creep torque ramps relative to brake torque. In particular, creep torque ramps in when brake torque drops below some calibratable threshold (in the example shown, the threshold 332). Various times are indicated at 330, 332, 334 and 336.

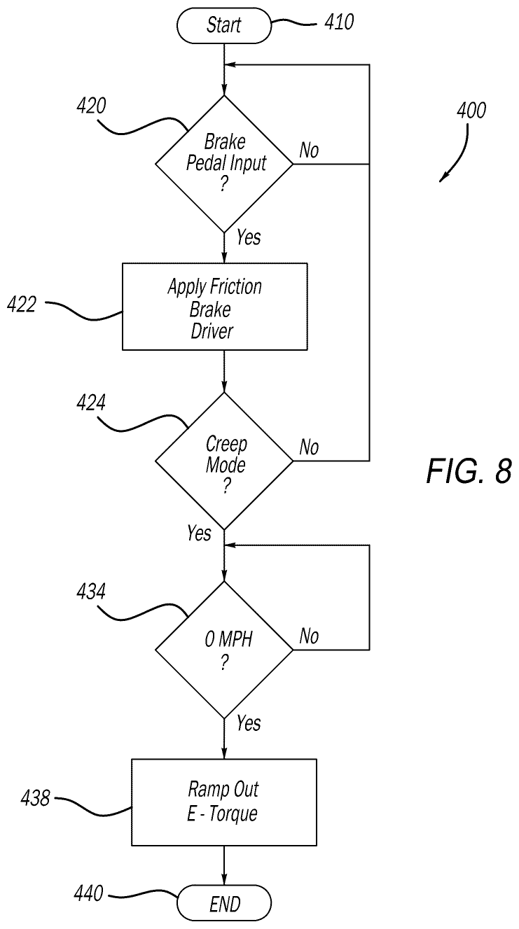

FIG. 8 is an exemplary method 400 of implementing electronic creep torque control with the controller 82 according to one example of the present disclosure. Control starts at 410. At 420 control determines whether a brake pedal input has been received from the brake pedal 72 at 420. If control determines that brake pedal input has not been received, control loops to 420. If control determines that a brake pedal input has been received, control applies friction brakes 60 at 422. At 424 control determines whether creep mode is active. If control determines that creep mode is not active, control loops to 420. If control determines that creep mode is active, control determines whether the speed of the vehicle 12 is zero at 434. If control determines that the vehicle speed is not zero, control loops to 434. If control determines that the vehicle speed is zero, control alters an e-torque input by the motor(s) 20 by ramping out of e-torque. It is appreciated therefore that an e-torque input is not modified until after a confirmation that the vehicle speed is zero. Control ends at 440.

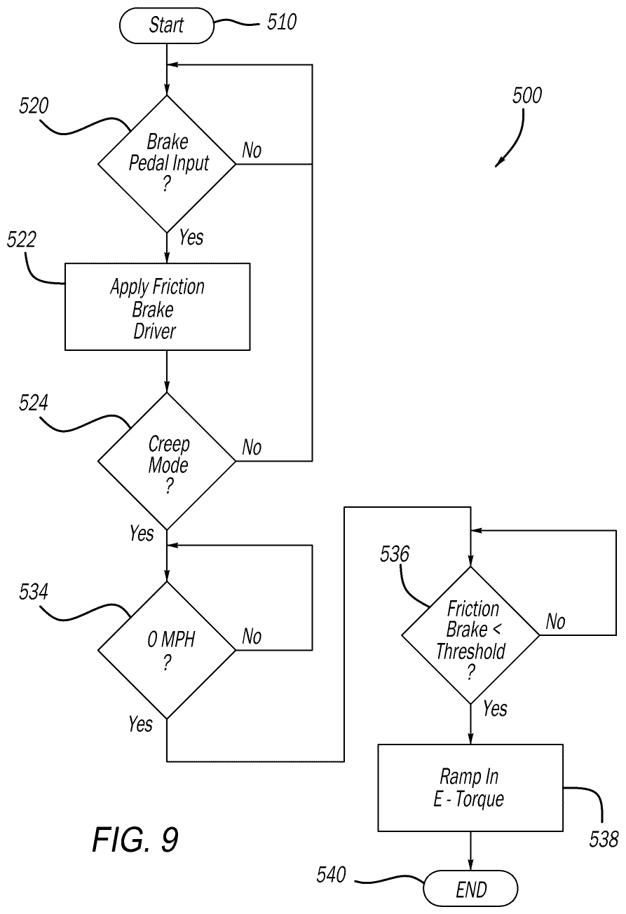

FIG. 9 is an exemplary method 500 of implementing electronic creep torque control with the controller 82 according to one example of the present disclosure. Control starts at 510. At 520 control determines whether a brake pedal input has been received from the brake pedal 72 at 520. If control determines that brake pedal input has not been received, control loops to 520. If control determines that a brake pedal input has been received, control applies friction brakes 60 at 522. At 524 control determines whether creep mode is active. If control determines that creep mode is not active, control loops to 520. If control determines that creep mode is active, control determines whether the speed of the vehicle 12 is zero at 534. If control determines that the vehicle speed is not zero, control loops to 534. If control determines that the vehicle speed is zero, control determines whether the friction brake input is less than a threshold (see FIG. 7 and related discussion). If control determines that the friction brake input is not less than a threshold, control loops to 536. If control determines that the friction brake input is less than a threshold, control alters an e-torque input by the motor(s) 20 by ramping in e-torque. It is appreciated therefore that an e-torque input is not modified until after a confirmation that the vehicle speed is zero. Control ends at 540.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vehicle system for an electrified vehicle that implements electronic creep torque control, the vehicle system comprising:
an electric motor that provides drive torque to a driveline that drives vehicle wheels for propelling the vehicle;
a friction brake that applies a friction brake input to at least one of the vehicle wheels based on an input from a brake pedal;
a controller that:
determines whether a brake pedal input is received by the brake pedal;
commands, based on the brake pedal input being received, the friction brake to apply a friction brake input;
determines whether a creep mode is activated, the creep mode including an electric motor input to the driveline;
determines, based on the creep mode being activated, whether a speed of the electrified vehicle is zero; and
commands, based on a determination that the electrified vehicle speed is zero, the electric motor to one of ramp in and ramp out of the electric motor input.

2. The vehicle system of claim 1, wherein the controller determines whether the creep mode is activated based on a drive mode input.

3. The vehicle system of claim 1, wherein the controller determines whether the creep mode is activated based on an accelerator pedal input.

4. The vehicle system of claim 1, wherein the controller determines whether the creep mode is activated based on a brake pedal input.

5. The vehicle system of claim 1, wherein the controller determines whether the creep mode is activated based on a vehicle speed.

6. The vehicle system of claim 1, wherein the controller determines whether the creep mode is activated based on a shifter position.

7. The vehicle system of claim 1, wherein the controller determines whether the creep mode is activated based on a park brake input.

8. The vehicle system of claim 1, wherein the controller determines whether a speed of the electrified vehicle is zero based on an input from a wheel speed sensor.

9. The vehicle system of claim 1, wherein the controller further:
determines whether a friction brake input is less than a threshold value; and
based on a determination that the friction brake input is less than the threshold value, commands the electric motor to ramp in the electric motor input.

10. A method for implementing electronic creep torque control for an electrified vehicle that includes an electric motor that provides drive torque to a driveline that drives vehicle wheels for propelling the vehicle; and a friction brake that applies a friction brake input to at least one of the vehicle wheels based on an input from a brake pedal, the method comprising:
determining whether a brake pedal input is received by the brake pedal;
commanding, based on the brake pedal input being received, the friction brake to apply a friction brake input;
determining whether a creep mode is activated, the creep mode including an electric motor input to the driveline;
determining, based on the creep mode being activated, whether a speed of the electrified vehicle is zero; and
commanding, based on a determination that the electrified vehicle speed is zero, the electric motor to one of ramp in and ramp out of the electric motor input.

11. The method of claim 10, wherein the controller determines whether the creep mode is activated based on a drive mode input.

12. The method of claim 10, wherein the controller determines whether the creep mode is activated based on an accelerator pedal input.

13. The method of claim 10, wherein the controller determines whether the creep mode is activated based on a brake pedal input.

14. The method of claim 10, wherein the controller determines whether the creep mode is activated based on a vehicle speed.

15. The method of claim 10, wherein the controller determines whether the creep mode is activated based on a shifter position.

16. The method of claim 10, wherein the controller determines whether the creep mode is activated based on a park brake input.

17. The method of claim 10, wherein the controller determines whether a speed of the electrified vehicle is zero based on an input from a wheel speed sensor.

18. The method of claim 10, further comprising:
determining whether a friction brake input is less than a threshold value; and
based on a determination that the friction brake input is less than the threshold value, commanding the electric motor to ramp in the electric motor input.
